(19) United States
(12) Patent Application Publication
(10) Pub. No.: US 2007/0088899 A1
(43) Pub. Date: Apr. 19, 2007

(54) Tape drive apparatus and method

(76) Inventors: Andrew Topham, Dursley (GB); John G. McCarthy, Fort Collins, CO (US); Stan S. Feather JR., Longmont, CO (US); Shiraz Billimoria, Bristol (GB); Neil Johnson, Cam (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/252,109

(22) Filed: Oct. 17, 2005

(51) Int. Cl. G06F 12/00; G06F 13/00

(52) U.S. Cl. 711/4; 711/111

(57) ABSTRACT

In a tape drive apparatus commonly shared by a plurality of host devices coupled to the tape drive apparatus over a host port, access control is provided. Each host device is identified by a host address. The tape drive apparatus comprises a data transfer unit for transferring data between a loaded tape medium and the tape drive apparatus. A command for registering a host address of one of the plurality of host devices in the tape drive apparatus for the purpose of authorising access is received over a management port. A command comprising data to be stored on the tape medium is received from a requesting host device over the host port. The host address of the requesting host device is derived from the command received over the host port. The host address of the requesting host device is verified against the host address registered in the tape drive apparatus to determine whether or not the requesting host device has access authorisation. The requesting host device is denied access to the data transfer unit when the requesting host device does not have access authorisation.

### FIELD OF THE INVENTION

The present invention relates to the field of tape drive apparatuses, and more particularly without limitation to the field of controlling access in a tape apparatus.

### BACKGROUND AND PRIOR ART

In a networked environment of computing devices it is possible for a device to be accessible to many other devices in the network. For example, in the case of a storage area network (SAN), a tape drive may be accessible by many host computers. This can be disadvantageous for a tape drive since tape drives operate on the principle that only one host computer is accessing the tape media at any one time. In practice it is necessary to control access to tape drives on a storage area network.

A known method of controlling access in a storage area network using the fibre channel protocol is fibre channel fabric zoning. One of several ways of applying fibre channel fabric zoning restricts access to devices by their world-wide name, a unique identifier of devices in a fibre channel network. However, changing access rights can require changing settings in a possibly great number of network switches that make up the fibre channel fabric and is therefore not well suited in situations when access rights to individual devices have to be changed dynamically.

The small computing system interface (SCSI) set of primary commands (SPC) provides a pair of reserve and release commands that can be used for controlling access. A host device obtains a lock on a tape drive by sending a reserve command to the tape drive, which then effectively blocks all other host devices from accessing the tape drive until a corresponding release command is received from the same host device. This method, however, is easily confused, for example by a misbehaving host device, which can block the tape drive indefinitely, or by resets of the SCSI bus, which can happen under a number of conditions including a reboot of any one of the connected host devices.

The SCSI set of primary commands furthermore provides an explicit access controls functionality that is intended to be used to restrict access at a device level to specified host devices. However, the functionality relies on sending access enabling commands over the storage area network itself. This is problematic because it implies that a strict security process has to be maintained to control access to the access control lists, or otherwise risk corruption of the access control lists by malfunctioning host devices. The functionality also relies on the tape drive using a concept of “well-known logical units” which, albeit part of the SCSI specification, is not a currently accepted methodology and is not expected to become widely accepted.

Non-tape devices such as disk arrays are known that provide methods for controlling access to the devices on a storage area network. However, disk systems are not as stateful as a tape drive and so do not present the same range of challenges when multiple hosts connect to them.

U.S. Pat. No. 6,219,771 discloses a disk apparatus that can be accessed by a plurality of host devices. The apparatus enables access authorisation to be assigned solely to specific host devices. A control device comprises an address registration unit, in which the host address of each host device has been registered for authorizing access, a command interpretation and execution unit which on receipt of a command from a host device via a host device interface outputs the host address of the host device based on the command, and an address verification unit for verifying the host address output from a command interpretation and execution unit against the host address registered in the address registration unit, as well as determining whether or not the particular host device has access authorisation.

### SUMMARY OF THE INVENTION

In accordance with the present invention there is provided a tape drive apparatus comprising a data transfer unit for transferring data between a loaded tape medium and the tape drive apparatus. The tape drive apparatus further comprises a host port for receiving from a plurality of host devices commands comprising data to be stored on the tape medium, each host device being identified by a host address, and a management port for receiving commands for registering the host address of one of the plurality of host devices in the tape drive apparatus for the purpose of authorising access.

The tape drive further comprises an address deriving unit for deriving from a command received from a requesting host device over the host port the host address of the requesting host device, an address verification unit for verifying the host address of the requesting host device against the host address registered in the tape drive apparatus to determine whether or not the requesting host device has access authorisation, and an access control unit for denying the requesting host device access to the data transfer unit when the requesting host device does not have access authorisation.

In accordance with an embodiment, a plurality of registered host addresses are registered in a host access table stored in the tape drive apparatus. The address verification unit verifies the host address of the requesting host device against each of the registered host addresses in the host access table. This embodiment is particularly advantageous because it enables to allow or disallow access of more than one host device to the tape drive apparatus at the same time.

In accordance with an embodiment, the host access table comprises a mapping of registered host addresses to access rights descriptors. The address verification unit determines whether the requesting host device has access authorization based on the access rights descriptor. The requesting host device is determined to have access authorisation when the host address of the requesting host device is verified to be mapped to an access rights descriptor specifying access authorisation. This embodiment is particularly advantageous because it enables fine-grained control of access rights granted to a particular host device. For example, the access authorisation of the requesting host device can be made dependent on the time of day, or the kind of the command received from the host device, the dependencies being encoded in the access rights descriptor.

In accordance with an embodiment, the requesting host device is determined to not have access authorisation if the host address of the requesting host device is verified not to be registered in the tape drive apparatus. This embodiment is particularly advantageous because it enables to protect the tape drive apparatus from potentially dangerous commands that originate at host devices unregistered and therefore unknown to the tape drive apparatus.

In accordance with an embodiment, the plurality of host devices is coupled to the host port of the tape drive apparatus by means of a storage area network. In accordance with a further embodiment, the management port is a serial port. These embodiments are particularly advantageous because frequently tape drive apparatuses are already equipped with ports for connecting to a storage area network, and also with serial ports for other purposes such as being remote-controlled by a library controller. Since the amount of data to be transmitted over the management port is small, the functionality of the management port lends itself to integration with functionality of an existing serial port. It is therefore possible to implement these embodiments on the basis of existing tape drives, without adding further hardware ports.

In accordance with an embodiment, a reply is sent to the requesting host device over the host port when the requesting host device does not have access authorisation. The reply signals that the command received from the requesting host device terminated unsuccessfully. This embodiment is particularly advantageous because it enables providing the requesting host device with minimal information that allows it to trigger appropriate error routines, avoiding futile repetition or waiting for a completion of the command.

### BRIEF DESCRIPTION OF THE DRAWINGS

In the following preferred embodiments of the invention will be described in greater detail by way of example only making reference to the drawings in which:

FIG. 1 is a block diagram of a tape drive apparatus of the invention,

FIG. 2 is a flowchart illustrating a method of controlling access in a tape drive of the invention, and

FIG. 3 is a block diagram of a tape library of the invention.

### DETAILED DESCRIPTION

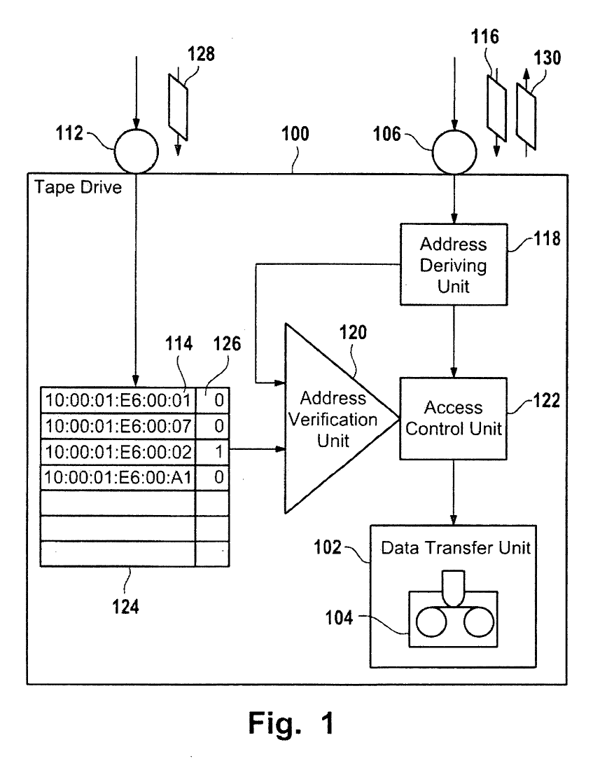

FIG. 1 is a block diagram of a tape drive apparatus 100 for writing data to and reading data from a tape medium 104. The tape drive apparatus 100 comprises a data transfer unit 102 capable of loading a tape medium 104 and of transferring data between the loaded tape medium 104 and the tape drive apparatus 100.

The tape drive apparatus 100 comprises a host port 106 for coupling to a plurality of host devices in such a way that the tape drive apparatus 100 is commonly shared between the host devices by enabling it to receive commands 116 over the host port from each of the plurality of host devices. Preferably, the host port 106 is implemented according to the specifications of a storage-area-network (SAN) technology standard such as the fibre channel, iSCSI, or ATA-over-Ethernet networking standards. Using the host port 106 and correspondingly implemented ports in each of the host devices, the tape drive apparatus 100 and the plurality of host devices are connected to each other by means of a storage area network, within which each host device is identified by a unique host address.

The tape drive apparatus 100 further comprises a management port 112 that is separate from the host port 106 and enables the tape drive apparatus 100 to receive commands 128 for registering the host address 114 of one or more of the plurality of host devices in the tape drive apparatus 100. A suitable registering device functioning as the sender of the commands 128 needs to be connected to the management port 112. Considering that the commands 128 impose only modest demands on speed and capacity of the connection, the management port 112 is implemented preferably as a serial port or otherwise using a technology standard that can be implemented within the limits of the processing capabilities in the tape drive apparatus 100.

Host addresses 114 registered in the tape drive apparatus 100 preferably are stored in a host access table 124, which can for example be implemented as a data structure supported by volatile or non-volatile memory in the tape drive apparatus 100. The host access table 124 lists each registered address 114 of a host device along with an associated access rights descriptor 126, forming a mapping of host addresses 114 to access rights descriptors 126. Each access rights descriptor 126 describes the access rights granted to the respective registered host. The range of values an access rights descriptor can assume and their respective meaning in terms of which access rights are granted can be defined depending on the range of capabilities of the tape drive apparatus and the requirement for fine-grained control of access to these capabilities.

For example, access rights descriptors 126 can be allowed to take a value of either 1 or 0, where a registered host address mapped to an access rights descriptor of 1 means that the corresponding host device has access authorisation, whereas a registered host address mapped to an access rights descriptor of 0 means that the corresponding host device does not have access authorisation. If in operation commands 128 are sent over the management port 112 to the tape drive apparatus 100 that cause the host address of a single host device to be registered and mapped to an access rights descriptor of value 1 in the host access table 124 whereas all other registered addresses are mapped to an access rights descriptor of value 0 in the host access table, only the single host device has access authorisation. Preferably, host devices that do not have their host address registered in the host access table 124 are treated as not having access authorisation. However, the default access rights of such hosts can also be defined differently, for example by defining every host device to have access authorisation unless its host address is registered in the host access table 124 and mapped to an access rights descriptor 126 of value 0.

The disk drive apparatus 100 comprises an address deriving unit 118 for analysing commands 116 received by the tape drive apparatus 100 from individual host devices of the plurality of host devices over the host port 106. While the exact form of the commands 116 depends on the protocol used in the storage area network, a commonality of the fibre channel, iSCSI, and ATA-over-Ethernet networking standards is that commands 116 are transported as data frames that include the host address of a requesting host device having sent the commands. The address deriving unit 118 enables the tape drive apparatus 100 to derive the host address of the requesting host device from a command 116 received over the host port by extracting it from the data frames as which the command 116 is transported.

The disk apparatus 100 further comprises an address verification unit 120 for verifying the host address of the requesting host device as provided by the address deriving unit 118 against the registered host addresses 114 in the host access table 124, in order to determine whether or not the requesting host device has access authorisation.

An access control unit 122 enables the tape drive apparatus 100 to either allow or deny the requesting host device access to the data transfer unit, relying on the determination of the address verification unit 120 of whether or not, respectively, the requesting host device has access authorisation. Preferably, the access control unit 122 enables the tape drive apparatus to send a reply 130 to the requesting host device over the host port 106 when the requesting host device does not have access authorisation, the reply 130 signalling the requesting host device that the command terminated unsuccessfully.

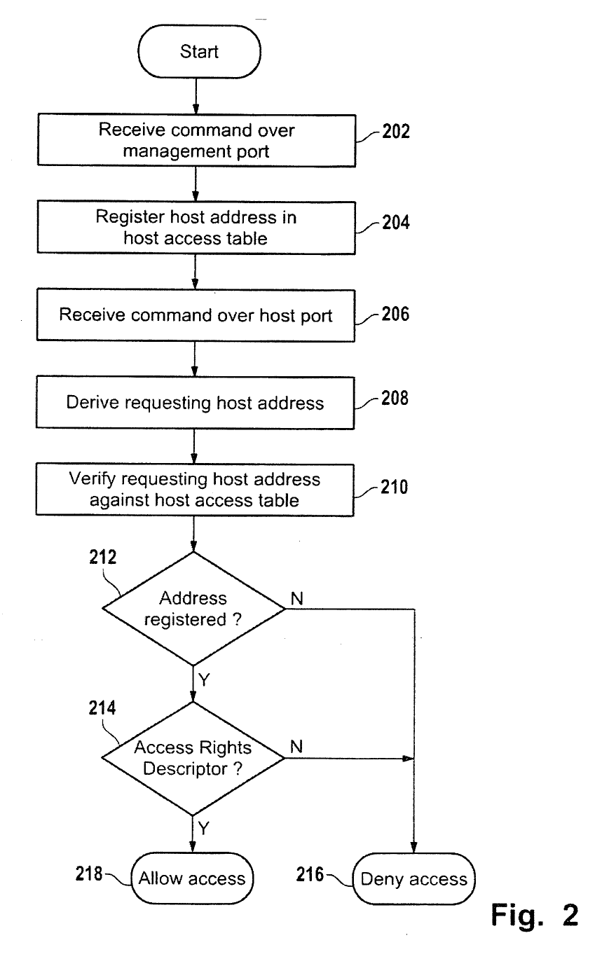

FIG. 2 is a flowchart depicting an embodiment of a method of the invention, which enables to control access in the tape drive apparatus. In step 202, a command is received over the management port of the tape apparatus, originating at a controller device such as a library controller of a tape library of which the tape drive apparatus is part. The command includes the host address of a host device and preferably an access rights descriptor that encodes the access rights to be granted the host device for accessing the tape drive apparatus.

In step 204, the command received over the management port is executed, and the host address specified in the command is registered in the host access table of the tape drive apparatus. The access rights descriptor is stored along with the registered host address, resulting in a mapping of the registered host address to the access rights encoded in the access rights descriptor. If the host access table already included an entry for the registered host address before step 204, no new entry is added to the host access table but the existing entry updated instead, overwriting the access rights descriptor existing in the host access table with the access rights descriptor included in the command.

In step 206, a command is received over the host port of the tape drive apparatus, having been sent by a requesting host device of the plurality of host devices coupled to the host port by means of a storage area network. The command is addressed to the tape drive apparatus and comprises data to be stored on a tape medium loaded in the data transfer unit of the tape drive apparatus.

In step 208, the host address of the requesting host device that sent the command received over the host port is derived from the command. The data frames that transported the command from the requesting host device over the storage area network to the host port include the host address of the requesting host device, allowing it to be derived by extracting the host address from such a data frame.

In step 210, the requesting host address as derived from the command received over the host port is verified against the host access table. If the requesting host address is not found to match any of the host addresses registered in the host access table, a decision 212 is made to deny 216 the requesting host access to the data transfer unit, so that the command received over the host port and comprising data to be stored on a tape medium is not carried out. If the requesting host address is successfully matched to one of the host addresses registered in the host access table, the access rights descriptor mapped to by the matching host address is interpreted and a decision 214 made accordingly. Access to the data transfer unit is allowed 218 if the access rights descriptor specifies that the requesting host device has access authorisation, whereas access is denied 216 if the access rights descriptor specifies that the requesting host device does not have access authorisation. If access is allowed 218, the command received over the host port is carried out and the data transfer unit controlled to store the data comprised by the command on the loaded tape medium.

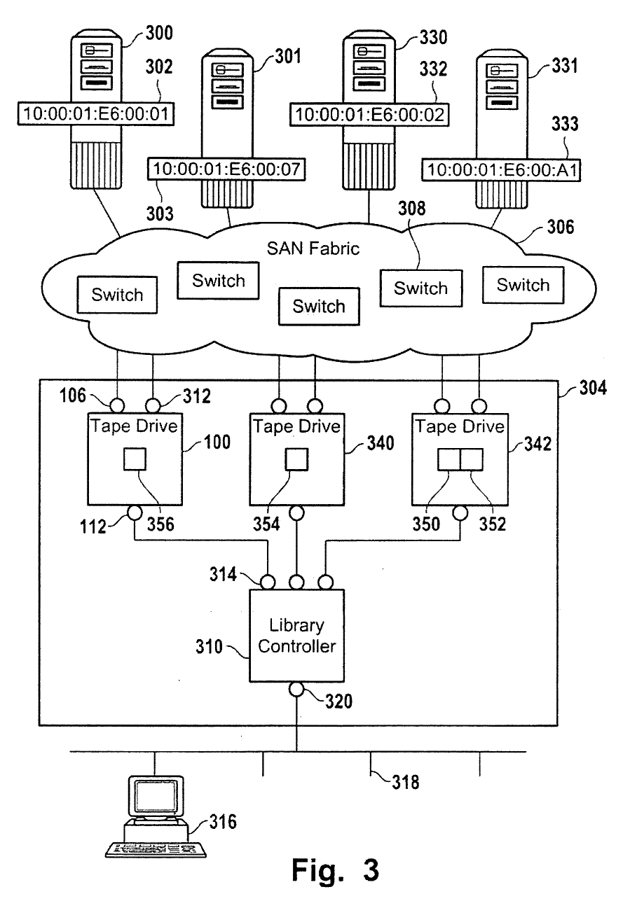

FIG. 3 is a block diagram of a tape library 304 of an embodiment. The tape library 304 comprises a plurality of tape drives 100, 340, 342, each of which is equipped with a host port 106 and an additional failover port 312 for taking over the functionality of the host port 106 in case of failure. Both the host port 106 and the failover port 312 are connected to a storage area network 306 that has the topology of a switched fabric. All devices participating in the storage area network 306 connect with each other via fibre channel switches 308. Furthermore connected to the storage area network 306 are a plurality of host devices 300, 301, 330, 331 that share the tape drives 100, 340, 342 of the tape library 304. Each of the host devices 300, 301, 330, 331 is identified in the storage area network by a corresponding host address 302, 303, 332, 333. The host addresses 302, 303, 332, 333 in a fibre channel network are provided by the fibre channel device property known as world-wide name.

Each of the tape drives 100, 340, 342 further comprises a management port 112 that is connected to a corresponding drive port 314 of a library controller 310 of the tape library 304. The library controller 310 preferably comprises a robotic device for transporting tape media among various storage bins and the tape drives 100, 340, 342, and for loading tape media into and removing tape media from the tape drives 100, 340, 342. It further comprises a management station port 320 for connecting to a management station 316 over a communications link such as local-area network 318 that is separate from the storage area network 306.

In operation, the management station 316 sends commands over the local area network 318 and the management station port 320 to the library controller 310 for registering one of the host addresses 302, 303, 332, 333 in one of the tape drives 100, 340, 342. For example, in order to grant host device 301 access to tape drive 340, the management station 316 sends to the library controller 310 commands for registering the host address 303 of host device 301 in tape drive 340. The library controller 310 receives the commands, analyses them to determine for which of the tape drives 100, 340, 342 the commands are destined, and accordingly forwards the commands to the tape drive 340. Tape drive 340 interprets the commands and accordingly registers host address 303 in a host access table. By forwarding such and analogous commands to the individual tape drives 100, 340, 342 the library controller 310 enables the management station 316 to manipulate the host addresses and associated access rights descriptors registered in respective host access tables of each of the tape drives 100, 340, 342, and thereby to control the access granted to each of the host devices 300, 301, 330, 331 in each of the tape drives 100, 340, 342.

A preferred way of operating the robotic device of the library controller 310 is to enable the library controller 310 to receive commands for controlling robotic device functions over the storage area network 306 from a robot traffic host 331 of the plurality of host devices. In the embodiment shown in FIG. 3, a master drive 342 of the plurality of tape drives 100, 340, 342 is equipped to recognise on the storage area network 306 a first address 350 for tape drive functions, and a second address 352 for robotic device functions, whereas the remaining tape drives 100, 340 respectively recognise a single address 354, 356 for tape drive functions. On a storage area network 306 using a network protocol such as fibre channel that conforms to the SCSI architecture model, the first and second addresses preferably comprise first and second logical unit numbers (LUN). In operation, a data traffic host of the plurality of host devices 300, 301, 330, 331 sends commands concerning data traffic with the master drive 342 to the first address 350 of the master drive 342. The robotic traffic host 331 sends commands for controlling robotic device functions to the second address 352. The master drive 342 processes the commands sent to the first address internally using its own tape drive functions, and forwards the commands sent to the second address over the management port to the library controller 310.

Separate access control for tape drive functions of the master drive 342 and for robotic device functions of the library controller 310 is enabled by suitably extended access rights descriptors in the host access table of the master drive 342. For example, access rights descriptors 126 can be assigned double-bit values, where one of the bits signifies access authorization for the tape drive functions, and the other bit signifies access authorization for the robotic device functions.

At least some of the embodiments are advantageous in enabling control of access in a tape drive apparatus in a highly secure way because of the physical separation of the host port and the management port. This physical separation makes it difficult or impossible to override or disable the access control by sending commands to the host port, for example from hosts devices that behave improperly due to malfunctioning, restarting, or executing erroneous or malicious program instructions. Access control is inherently secure also for the host devices since commands for controlling access are sent to the management port over a connection that is independent of the network connecting host devices and tape drive apparatus. Furthermore, implementation of such access control is computationally undemanding and therefore lends itself well to the limited processing power available in a tape drive.

### LIST OF REFERENCE NUMERALS

100 Tape drive apparatus
102 Data transfer unit
104 Tape medium
106 Host port
112 Management port
114 Registered host address
116 Command from requesting host device
118 Address deriving unit
120 Address verification unit
122 Access control unit
124 Host access table
126 Access rights descriptor
128 Command for registering a host address
130 Reply to requesting host device
202 Command reception over management port
204 Registration of host address
206 Command reception over host port
208 Derivation of host address
210 Verification of host address
212 Determination whether address is registered
214 Interpretation of access rights descriptor
216 Denying of access
218 Allowing of access
300, 301, 330, 331 Host devices
302, 303, 332, 333 Host addresses
304 Tape library
306 Storage area network fabric
308 Storage area network switch
310 Library controller
312 Failover port
314 Drive port
316 Management station
318 Local area network
320 Management station port
340 Tape drive
342 Master tape drive
350, 354, 356 Address for tape drive functions
352 Address for robotic device functions

1. A tape drive apparatus comprising:
a data transfer unit for transferring data between a loaded tape medium and the tape drive apparatus,
a host port for receiving from a plurality of host devices commands comprising data to be stored on the tape medium, each host device being identified by a host address,
a management port for receiving commands for registering the host address of one of the plurality of host devices in the tape drive apparatus for the purpose of authorising access,
an address deriving unit for deriving from a command received from a requesting host device over the host port the host address of the requesting host device,
an address verification unit for verifying the host address of the requesting host device against the host address registered in the tape drive apparatus to determine whether or not the requesting host device has access authorisation, and
an access control unit for denying the requesting host device access to the data transfer unit when the requesting host device does not have access authorisation.

2. The tape drive apparatus of claim 1, wherein a plurality of registered host addresses are registered in a host access table stored in the tape drive apparatus, the host address of the requesting host device being verified against each of the registered host addresses.

3. The tape drive apparatus of claim 2, wherein the host access table comprises a mapping of registered host addresses to access rights descriptors, the requesting host device being determined to have access authorisation when the host address of the requesting host device is verified to be mapped to an access rights descriptor specifying access authorisation.

4. The tape drive apparatus of claim 1, the requesting host device being determined to not have access authorisation if the host address of the requesting host device is verified not to be registered in the tape drive apparatus.

5. The tape drive apparatus of claim 1, wherein the management port is a serial port.

6. The tape drive apparatus of claim 1, the plurality of host devices being coupled to the host port of the tape drive apparatus by means of a storage area network.

7. The tape drive apparatus of claim 1, the access control unit being operational for sending a reply to the requesting host device over the host port when the requesting host device does not have access authorisation, the reply signalling that the command received from the requesting host device terminated unsuccessfully.

8. A method of controlling access in a tape drive apparatus commonly shared by a plurality of host devices coupled to the tape drive apparatus over a host port, each host device being identified by a host address, the tape drive apparatus comprising a data transfer unit for transferring data between a loaded tape medium and the tape drive apparatus, the method comprising:
receiving over a management port a command for registering the host address of one of the plurality of host devices in the tape drive apparatus for the purpose of authorising access,
receiving over the host port a command from a requesting host device of the plurality of host devices, the command comprising data to be stored on the tape medium,
deriving from the command received from the requesting host device the host address of the requesting host device,
verifying the host address of the requesting host device against the host address registered in the tape drive apparatus to determine whether or not the requesting host device has access authorisation, and
denying the requesting host device access to the data transfer unit when the requesting host device does not have access authorisation.

9. The method of claim 8, wherein a plurality of registered host addresses are registered in a host access table stored in the tape drive apparatus, the host address of the requesting host device being verified against each of the registered host addresses.

10. The method of claim 9, wherein the host access table comprises a mapping of registered host addresses to access rights descriptors, the requesting host device being determined to have access authorisation when the host address of the requesting host device is verified to be mapped to an access rights descriptor specifying access authorisation.

11. The method of claim 8, the requesting host device being determined to not have access authorisation if the host address of the requesting host device is verified not to be registered in the tape drive apparatus.

12. The method of claim 8, the management port being a serial port.

13. The method of claim 8, the plurality of host devices being coupled to the host port of the tape drive apparatus by means of a storage area network.

14. The method of claim 8, further comprising sending a reply to the requesting host device over the host port when the requesting host device does not have access authorisation, the reply signalling that the command received from the requesting host device terminated unsuccessfully.

15. A computer program product for controlling access in a tape drive apparatus, the tape drive apparatus comprising a data transfer unit for transferring data between a loaded tape medium and the tape drive apparatus, a host port for receiving from a plurality of host devices commands comprising data to be stored on the tape medium, each host device being identified by a host address, and a management port for receiving commands for registering the host address of one of the plurality of host devices in the tape drive apparatus for the purpose of authorising access, the computer program product comprising instructions for:
deriving from a command received from a requesting host device over the host port the host address of the requesting host device,
verifying the host address of the requesting host device against the host address registered in the tape drive apparatus to determine whether or not the requesting host device has access authorisation, and
denying the requesting host device access to the data transfer unit when the requesting host device does not have access authorisation.

16. A tape library comprising a plurality of tape drives, at least one of the tape drives comprising:
a data transfer unit for transferring data between a loaded tape medium and the tape drive,
a host port for receiving from a plurality of host devices commands comprising data to be stored on the tape medium, each host device being identified by a host address,
a management port for receiving commands for registering the host address of one of the plurality of host devices in the tape drive for the purpose of authorising access,
an address deriving unit for deriving from a command received from a requesting host device over the host port the host address of the requesting host device,
an address verification unit for verifying the host address of the requesting host device against the host address registered in the tape drive to determine whether or not the requesting host device has access authorisation, and
an access control unit for denying the requesting host device access to the data transfer unit when the requesting host device does not have access authorisation.

17. The tape library of claim 16, further comprising a library controller, the library controller being connected to the management port of the at least one of the tape drives.

18. A tape storage device comprising:
means for transferring data between a loaded tape medium and the tape drive apparatus,
a host port for receiving from a plurality of host devices commands comprising data to be stored on the tape medium, each host device being identified by a host address,
a management port for receiving commands for registering the host address of one of the plurality of host devices in the tape drive apparatus for the purpose of authorising access,
means for deriving from a command received from a requesting host device over the host port the host address of the requesting host device,
means for verifying the host address of the requesting host device against the host address registered in the tape drive apparatus to determine whether or not the requesting host device has access authorisation, and
means for executing the command received from the requesting host device only when the requesting host device is determined to have access authorisation.
